(19) United States
(12) Patent Application Publication
(10) Pub. No.: US 2014/0345188 A1
(43) Pub. Date: Nov. 27, 2014

(54) ANIMAL TRAPS COMMUNICATING A MESSAGE

(71) Applicant: LearningWorks Limited, Hamilton (NZ)

(72) Inventors: Trevor Allan Connolly, Hamilton (NZ); Kevin William Stewart, Hamilton (NZ)

(21) Appl. No.: 14/351,788

(22) PCT Filed: Oct. 15, 2012
(86) PCT No.: PCT/NZ2012/000186

§ 371 Date: Apr. 14, 2014

(30) Foreign Application Priority Data
Oct. 15, 2011 (NZ) 592287

(51) Int. Cl. A01M 23/02

(52) U.S. Cl. CPC A01M 23/02
USPC 43/58

(57) ABSTRACT

An apparatus is provided for trapping animals, a carrier for use with same, and a method of trapping animals using same. The apparatus includes a reservoir for animal bait, a tubular housing for the reservoir where the housing has a lower end having an opening and the lower end is configured with a stop located on its outer circumference proximate to the opening of the housing, a plurality of resilient loops, a release mechanism for the loops, and carriers for each loop, where each carrier is configured to be slidably moveable about the outer circumference of the housing when the housing is in a substantially vertical orientation, and wherein the release mechanism is configured to be activated to move the loop from its carrier onto the body of an animal activating the release mechanism.

### STATEMENT OF CORRESPONDING APPLICATIONS

This application is based on the Provisional specification filed in relation to New Zealand Patent Application Number 592287, the entire contents of which are incorporated herein by reference.

### TECHNICAL FIELD

The present invention relates to improvements in animal traps. The invention has particular application to trapping small animals.

### BACKGROUND ART

Many indigenous bird, reptile, and invertebrate species of New Zealand and other countries internationally, are under threat from invasive mammal species. These invasive species include stoats, feral ferrets and the ship rat amongst others. In other countries the threat may be presented by other classes of animal—for example the brown tree snake in Guam. These invasive species are collectively driving many indigenous species towards extinction by preying on their eggs, juveniles and adults or otherwise competing for resources.

Traditional techniques to control pest species can include large scale control operations which involve the distribution, by air or ground, of toxins such as sodium monofluoroacetate, otherwise known as 1080, over targeted areas of land. These methods can be seen as being non-selective, and there can be issues with persistence of some toxins used for pest control, such as brodifacoum, in the environment. If this is excessive, this can lead to the bioaccumulation of the toxins within animal tissues or the soil of the targeted area.

A more environmentally friendly option for targeting pest species is the use of animal traps. Numerous animal trap designs have been developed to restrain or kill pests, typically having a killing mechanism—for example, sprung levers or the like, or in some cases through the application of toxic chemicals—which present a risk of injury to users setting the trap.

U.S. Pat. No. 5,123,200 describes a holding type trap in which the head of an animal entering the trap is held, preventing the animal from withdrawing. Such a trap may only be activated once, and then need to be manually cleared and re-set. In order to be effective, single use traps require constant monitoring in order to ensure that the trap may be replaced or re-set to target other pests in the area. Such monitoring may be time intensive—particularly in remote, difficult to access areas—and thus cost prohibitive.

Also, even though the animal being trapped is usually a pest, and thus undesirable, for ethical reasons it is preferable for the trap to quickly and humanely exterminate the animal. The trap of U.S. Pat. No. 5,123,200 simply holds an animal in place until death by starvation or a person checking the trap disposes of the animal—prolonging the animal's suffering.

Similarly, U.S. Pat. No. 5,177,896 describes a trap in which a noose is applied to an animal. Movement of the animal tightens the noose, eventually trapping the animal in a stationary position once it reaches the end of a line attached to the noose. Again, the trap may only be used once—and does not kill the animal but restrains it for an indefinite period of time.

U.S. Pat. No. 7,918,050 describes a system for applying a resilient ring to the neck of an animal to cut off blood and air supply. While such a system provides a humane mechanism for rapidly exterminating a pest, deficiencies remain. Although U.S. Pat. No. 7,918,050 purports to provide a multi-use system, it requires the simultaneous movement of a plurality of resilient rings to successive positions along the trap. Such an arrangement could be susceptible to jamming, and difficult to reload.

It is an object of the present invention to address the foregoing problems or at least to provide the public with a useful choice.

All references, including any patents or patent applications, cited in this specification are hereby incorporated by reference. No admission is made that any reference constitutes prior art. The discussion of the reference states what their authors assert, and the applicants reserve the right to challenge the accuracy and pertinency of the cited documents. It will be clearly understood that, although a number of prior art publications are referred to herein, this reference does not constitute an admission that any of these documents forms parts of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

### DISCLOSURE OF THE INVENTION

According to one aspect of the present invention, there is provided an apparatus for trapping animals, the apparatus including:
a reservoir for animal bait, and
a tubular housing for the reservoir, the housing having a lower end having an opening, wherein the lower end is configured with a stop located on its outer circumference proximate to the opening of the housing,
a plurality of resilient loops, and
a release mechanism for the loops,
   the apparatus characterised in that
the apparatus includes a carrier for each loop, the carrier configured to be slidably moveable about the outer circumference of the housing when the housing is in a substantially vertical orientation, and wherein the release mechanism is configured to be activated to move the loop from its carrier onto the body of an animal activating the release mechanism.

According to another aspect of the present invention, there is provided a carrier for carrying a resilient loop, the carrier being configured to slideably move along a housing for an apparatus for trapping animals, wherein the housing is configured with a lower end having an opening, wherein the lower end is configured with a stop located on its outer circumference proximate to the opening of the housing,

the carrier characterised in that
it is dimensioned such that when carrying a resilient loop, an internal circumference of the carrier is such that the carrier is unable to pass the stop of the housing.

According to another aspect of the present invention, there is provided a method of trapping animals using an apparatus, wherein the apparatus includes a reservoir for animal bait, and a tubular housing for the reservoir, the housing having a lower end having an opening, wherein the lower end is configured with a flange about its outer circumference proximate to the opening of the housing, a plurality of resilient loops, and a release mechanism for the loops, wherein the apparatus includes a carrier for each loop, the carrier configured to be slideably moveable about the outer circumference of the housing when the housing is in a substantially vertical orientation, and wherein the release mechanism is configured to be activated to move the loop from its carrier onto the body of an animal activating the release mechanism, wherein the method is characterised by the steps of:
a) placing the apparatus in a substantially vertical orientation; and
b) placing bait for the animal into the reservoir; and
c) positioning the carrier relative to the release mechanism such that when activated by an animal, the release mechanism moves the loop from its carrier onto the body of the animal.

The apparatus of the present invention is intended to trap or otherwise kill animals by releasing a resilient ring about an animal's body.

In preferred embodiments of the present invention, the target animals are small mammals such as rodents or mustelids. For example, the target animals may be rats, mice, stoats or ferrets. Reference shall now be made throughout the remainder of the specification to the animal being trapped as being a rat. In New Zealand, ship rats (Rattus rattus) are considered to offer the greatest threat to indigenous ecosystems, while Norway rats (Rattus norvegicus) are more commonly regarded as household pests. The present invention is envisaged as being ideal for trapping both species of rats.

However, the use of the present invention to trap rats is not meant to be limiting and a person skilled in the art will appreciate that the present invention may be readily used to trap other small animals—for example possums. It should be appreciated while features of the present invention may be configured according to particular behaviour and/or expected size of a target animal species, the general principles may still apply.

The reservoir should be understood to mean a container or the like in which animal bait may be placed. Baits used for attracting rats may include cereal pellets, peanut butter and the like, although persons skilled in the art will appreciate that this is not meant to be limiting.

In preferred embodiments of the present invention, the reservoir is a mesh basket or the like. This allows for air to pass over the bait for maximum dispersal of the scent of the bait.

The reservoir may be positioned within a substantially vertically orientated housing. Having the housing orientated in a substantially vertical orientation may be important in order to encourage the rat to automatically assume body posture that allows for effective use of the trap. It is envisaged that such body position may include the animal extending their neck—reducing the likelihood of the resilient loop being applied to the head of the animal rather than neck. To assist in achieving this, it is envisaged that the reservoir may be positioned along the length of the housing based on the average standing height of the target animal.

In some embodiments of the present invention, the apparatus may be provided with a protrusion located below the reservoir. Such a protrusion may descend from the housing, or be fastened to another component of the trap or surrounding environment. In some embodiments, the protrusion may be hinged or deformable in an inwards direction, so that it does not hinder the trapping mechanism.

This protrusion acts as a “step” for the front legs of the animal, further encouraging the animal to assume a target posture for efficient use of the trap. In particular, it may be desirable for the animal to position their limbs at a height below the neck and head of the animal when eating the bait—i.e. the protrusion is preferably located below the reservoir at a distance such that an animal attempting access to the reservoir is likely to rest its limbs on the protrusion. In doing so, the resilient loop is less likely to be caught on the animal's limbs—resulting in a more effective killing process.

Furthermore, because of the substantially vertical orientation of the housing, once the animal is trapped it will generally fall down and away from the trap. This is an important advantage of the present invention, as it “clears” the trap for the next target animal. Similarly, the vertical orientation assists in clearing the used carrier, and gravity fed reloading of the trap with the next carrier and associated loop.

It should be appreciated that in this instance, the use of the term “vertical” is not meant to exclude housings that orientated at slight angles from 90°. For example, the housing may be orientated up to 45° (or more) from the vertical while still retaining the properties discussed herein.

In preferred embodiments of the present invention, the tubular housing is in an elongate tube—and will herein be referred to as such.

The elongate tube may be constructed from any suitable material, for example stainless steel. However, it is envisaged that the housing may be made of a plastics material such as UV resistant PVC or the like in order to reduce costs. Being UV resistant is important for longevity of the invention if it is to be used in environments in which it is to be exposed to sunlight for an extended period of time. Such material is also quite durable, and able to withstand minor shocks and knocks without damage.

It should be appreciated that the reservoir is suspended within the lower portion of the tube. It is envisaged that the reservoir should not be positioned too high within the tube, as the rat must attempt to access the bait in order for the trap to work effectively. The area of the tube beneath the reservoir should be understood to be the trapping chamber.

The carrier should be understood to be dimensioned such that it fits about the outer circumference of the housing. The carrier should be understood to act as a collar, encompassing fully or at least a substantial portion of the outer circumference of the housing. The carrier should be able to freely slide down the housing without being affected by any frictional contact with the housing.

It should be understood that the resilient loop fits about the outer circumference of the carrier.

In a preferred embodiment the carrier includes at least two sections which abut each other at a minimum of one point around the circumference of the carrier. The carrier may be configured such that activation of the release mechanism causes the sections to be released from each other such that the carrier is capable of falling from the housing, past the stop.

It should be appreciated that reference to the sections being released from each other is intended to encompass embodiments in which the sections remain connected by at least one point, for example by a hinge. It is envisaged that the form of the carrier in this regard may be at least partially dependent on the release mechanism.

Preferably the carrier is configured to carry the resilient loop proximate to the downwards edge of the carrier. It is envisaged that in doing so, on activation of the release mechanism the resilient loop may induce the sections of the carrier to fall away from the housing—clearing the way for the next carrier to fall into place. Further, this action may assist in directing the loop below the housing onto the animal.

In a preferred embodiment the carrier includes a holding means configured to hold the at least two sections together until released. On release of the holding means, the tension of the resilient loop may induce the sections to be drawn apart—particularly where the loop is carried proximate to the downwards edge of the carrier. It is envisaged that may reduce the degree of force the release mechanism may be required to create in order to release the resilient loop in comparison with a mechanism which is required to act against the taut loop.

It is envisaged that in this embodiment, the carrier may include a gap between the sections at the downwards edge at which the resilient loop is carried. This may further assist in directing the release of the loop, as the tension of the loop will force the sections towards each other across the gap.

Preferably the holding means is a latch. It is envisaged that the latch may have a hinged connection at one end to a section of the carrier, with the other end configured to engage with a receptacle on another section. The receptacle is preferably an aperture or slot, so that the release mechanism may engage with the latch from the interior of the carrier.

It should be appreciated that this is not intended to be limiting, and that the holding means may take any suitable form known to a person skilled in the art.

In another embodiment the carrier may be a compressible carrier, wherein the resilient loop compresses the carrier to reduce its internal diameter such that the carrier is unable to pass beyond the stop.

It should be appreciated that although the internal diameter of the carrier may be reduced when the resilient loop is placed upon it, the carrier may be dimensioned that even in its compressed state such that it is still able to slideably move up and down the outer circumference of the housing as required.

Such a compressible carrier may be a closed loop, and fabricated from a suitable resilient material such as plastic or metal mesh such that it is readily deformable. However, it will be appreciated that careful selection of the materials for fabricating the closed loop carrier will be necessary to ensure that even in its deformed state, the carrier is still able to freely move up and down the housing.

In exemplary embodiments of the present invention, the compressible carrier may be a partially open loop. This may allow the compression or reduction in internal diameter of the carrier to be achieved by bringing the two ends of the open loop closer together, while still conferring a requisite degree of structural integrity and weight (to assist in the downward movement of the carrier about the housing).

Reference to a stop should be understood to mean a protrusion on the outer circumference of the tubular housing configured to prevent passage of a carrier on which a resilient loop located. Preferably the stop is flange, or lip—although it should be appreciated that the stop may not extend around the entire circumference of the housing.

The resilient loop or band may be fabricated from any suitable resilient material that has a high degree of tension when stretched. For example, the resilient loop may be elastic or latex rubber. Other materials suitable for use for fabricating the resilient loops will be readily apparent to persons skilled in the art.

In preferred embodiments, the loop, when released, has an internal diameter of approximately 7 millimetres. The inventors have found that this allows the use of lamb tail docking rings, which are readily available to the public, and are of a size that allows the present invention to be readily used for targeting rat and stoat species (although smaller loops may be required for mice, and larger loops for ferrets).

A size larger than this can mean that insufficient tension is applied to the body of the rat being trapped. This may mean that the animal may take longer than intended to die, if that is the intention of the trap. A prolonged death is undesirable for humane reasons, and also may cause targeted animals to avoid the trap if a previously trapped animal is still alive and in the vicinity of the trap.

Of course, a person skilled in the art would appreciate that the dimensions of the loop may ultimately depend on the animal species being targeted, and the material from which the loop is manufactured.

For example, a loop intended to trap feral ferrets, which are considerably larger than all rat species currently present in New Zealand, may have a slack inner diameter of approximately 12 millimetres and an outer diameter of 19 millimetres.

It is envisaged that in order to achieve the requisite tension to be effective, it may be difficult for a user to fit the resilient loops to the carriers without the assistance of a tool. A number of tools are available for the spreading of resilient bands—for example docking or castration ring applicators. It should be appreciated that this is not intended to be limiting and that other methods of spreading the loops are envisaged—for example rolling a loop along a cone to an expanded diameter, inserting the cone into the carrier, and rolling the band of the cone onto the carrier.

The release mechanism should be understood to mean any suitable mechanism that disengages the loop from the carrier such that the loop contracts about the neck or body of the rat.

In some embodiments the release mechanism may require priming on setting of the trap. However, it is preferred that action of the release mechanism be repeatable without requiring manual intervention.

The release mechanism may act against the carrier itself to counteract the tensioning effect of the resilient loop. Alternatively, the release mechanism may act upon the loop itself.

In a preferred embodiment the release mechanism includes a trip member.

Preferably the trip member is a hammer on the end of a lever configured to rotate about at least one pivot point to act against the resilient loop or the holding means.

In another embodiment the trip member may include a projection configured to extend beyond the outer circumference of the housing.

In another exemplary embodiment, the release mechanism may be a peg or the like which causes the carrier to assume a tapered configuration. This urges the loop towards and off the bottom of the carrier and therefore the housing such that the loop moves onto the neck or body of the rat.

As discussed above, in exemplary embodiments of the present invention, the carrier is an open loop. This leaves a gap in the carrier such that the release mechanism can engage with the loop through the gap. In some embodiments of the present invention, the carrier may be provided with a number of cut-outs or slots about its circumference (the cut-outs opening about the downward facing edge of the carrier) to allow the release mechanism to engage with the loop at multiple points.

In preferred embodiments of the present invention, the release mechanism is activated by the animal being targeted.

In a preferred embodiment the release mechanism includes a biasing means configured to return the release mechanism to an original position following actuation of the release mechanism. As well as automatic reset of the trap, it is envisage that the biasing means may be useful in amplifying the trigger action—for example from an animal tugging or pushing on the bait reservoir—in order to generate sufficient force to bias against the loop and/or carrier.

In a preferred embodiment the release mechanism may be directly or indirectly linked to the bait reservoir.

For example, it is envisaged that movement of the bait reservoir may actuate the rotation of the lever to force the hammer against the holding means to release it. It is envisaged that the bait reservoir may be connected to the housing via biasing means, for example to retract the hammer and allow the next carrier to fall into place.

It is not beyond the scope of the present invention for the release mechanism to be activated through the use of electronic sensors. These sensors may be activated by changes in light, pressure or perhaps by the proximity.

For example, the interior walls of the housing proximate to the bait reservoir may be provided with pressure sensors, such that when the animal makes contact with the walls, the release mechanism is activated.

Alternatively, a light sensor may detect, a reduction in light when the animal enters the trap, thus indicating the presence of an animal and thereby activating the release mechanism.

Persons skilled in the art will appreciate that other sensor alternatives would be readily implemented. It will be appreciated that in these embodiments, the release mechanism may be a solenoid or the like to ensure movement of the release mechanism and therefore release of the loop from the carrier.

It will be appreciated that when sensors and electronic means of actuating the release mechanism are employed, the invention may require a small power source such as a long life battery. Alternatively, or additionally, the housing of the trap may be provided with a small solar cell.

It will be appreciated once the loop has been disengaged from its carrier, the carrier, which is free to assume its maximum dimension following removal of the loop, then slips down and off the housing. Subsequent carriers then fall down the housing until the next carrier reaches the flange of the housing.

A number of carriers and their associated resilient loops may be stacked on top of each other, enabling multiple uses of each trap without the need to re-set the trap (as is the case with many conventional traps which are single use only).

In preferred embodiments of the present invention, the housing is provided with a cover, particularly in the form of a tube wherein the tube has a greater diameter than the housing.

The cover may be made from any suitable material, such as UV resistant PVC tubing or another material that a skilled person would readily appreciate is suitable for the desired purpose.

Preferably, the housing is suspended within the cover by its upper edges so as to not interfere with the movement of the carriers down the body of the housing. The top portion of the cover tube may be provided with a cap, roof or similar structure which is removable to allow the housing and bait reservoir to be accessed.

The cover provides protection from inclement weather. In harsh conditions, the release mechanism may not be as efficient due to water affecting its operation.

As noted above, in preferred embodiments of the present invention, the interior of the cover may be provided with a protrusion that acts as a “step” for the animal, and urges it into a posture that allows for effective trapping and killing of the animal. This step may be hinged or otherwise deformable in some way.

Thus, in some embodiments of the present invention, this step may also act as the trigger for the release mechanism. This may assist in ensuring that the trap is only activated when the animal is in the desired posture.

The apparatus may be provided with a means to allow the trap to be self supporting. For example, the cover may be provided with legs that may be placed or inserted into the ground to allow apparatus to be self supporting. It should be appreciated that such supports may be connected to the housing rather than the cover.

In some embodiments of the present invention, the legs are extendable to allow the height of the trap relative to the ground to be adjusted. Persons skilled in the art will appreciate that this has a bearing on the animal species being targeted.

For example, to target mice, the trap may be positioned in the housing close to the ground such that larger animals, such as ferrets, are excluded. When targeting larger animals, smaller animals will be naturally excluded by raising the trap higher than the smaller animals can reach, although still within the reach of the target animals.

In some embodiments of the present invention, the legs are not adjustable and the height of the trap relative to the ground is determined by the extent to which the legs are inserted into the ground.

Alternatively, the housing or cover may be provided with a loop or ring at its upper end. This allows the apparatus to be suspended from an available structure as required. In yet another example, the housing or cover may be provided with lugs or the like to allow the apparatus to be fixed to a vertical structure such as a wall, fencepost or tree.

The present invention may provide a number of advantages over the prior art, particularly:
the ability to trap multiple animals before requiring manual intervention;
non-toxic trapping of multiple animals;
ease of transportation;
ease of installation and safe operation by users of the trap;
relative low cost of manufacture and operation.

### BRIEF DESCRIPTION OF THE DRAWINGS

FIG. 1 is a perspective view of an exemplary animal trap according to one embodiment of the present invention;

FIG. 2 is a perspective view of an exemplary carrier for use with an animal trap according to one embodiment of the present invention;

FIG. 3 is a perspective view of exemplary internal components of the animal trap according to one embodiment of the present invention;

FIG. 4 is a cross-sectional view of the animal trap according to one embodiment of the present invention;

FIG. 5 is a perspective view of an exemplary housing of the animal trap according to one embodiment of the present invention;

FIG. 6 illustrates operation of an exemplary carrier according to one aspect of the present invention, and

FIG. 7 illustrates an exemplary trap including a cover according to one embodiment of the present invention.

### BEST MODES FOR CARRYING OUT THE INVENTION

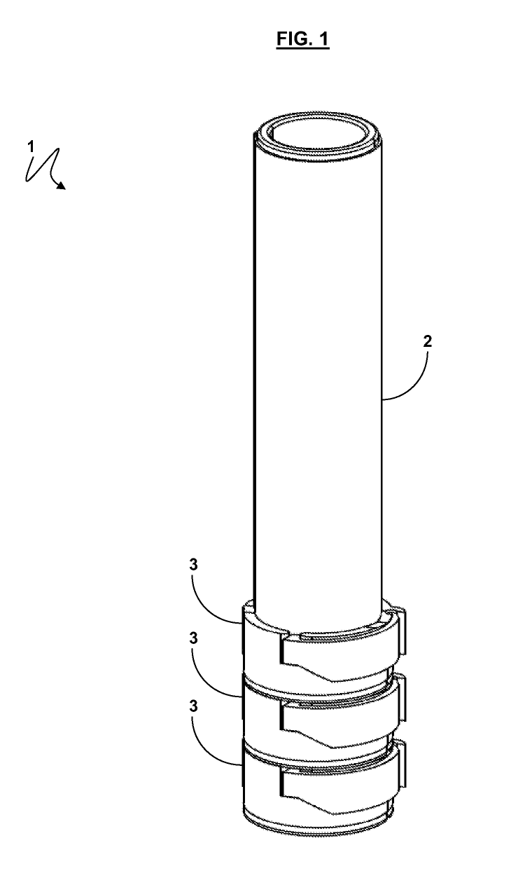

FIG. 1 illustrates an apparatus for trapping animals, generally indicated using arrow 1, and which will herein be referred to as the “trap”.

The trap 1 includes a vertically orientated tubular housing 2, on which a plurality of carriers 3 are slidably mounted.

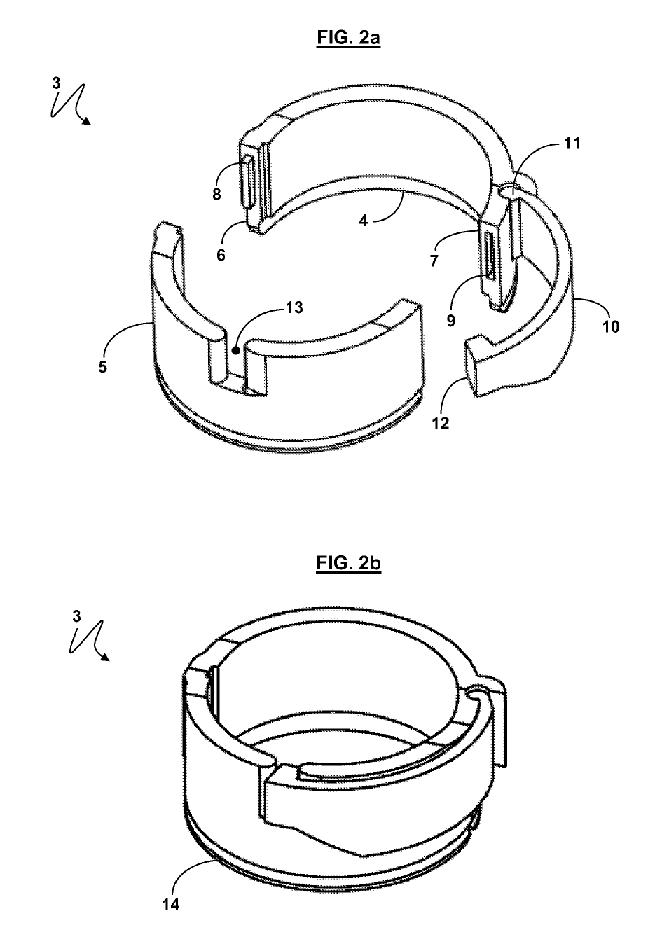

FIG. 2a and FIG. 2b illustrate a carrier 3 in more detail. The carrier 3 includes a first section 4 and a second section 5—each section forming substantially half of the carrier 3.

The first section 4 has a first end 6 and a second end 7—including a male 8 and female locator 9 respectively. These locators 8 and 9 correspond to counterpart locators (not illustrated) on the ends of the second section 5, such that the sections 4 and 5 are guided fit together to form a continuous shape.

The first section 4 also includes a latch 10. One end of the latch 10 is connected to the first section 4 by a hinge 11. The other end 12 is configured to engage with an aperture 13 in the second section.

The assembled carrier 3 is illustrated in FIG. 2b. The carrier 3 includes a groove 14 proximal to the downwards facing edge of the carrier 3. The groove 14 is configured to locate a resilient band (not illustrated) in place until triggered by an animal (not illustrated). It is envisaged that a high degree of tension is required of the resilient band in order to be effective. Such tension may require the use of a tool—such as a docking or castration ring applicator—to spread the band and release it into the groove 14.

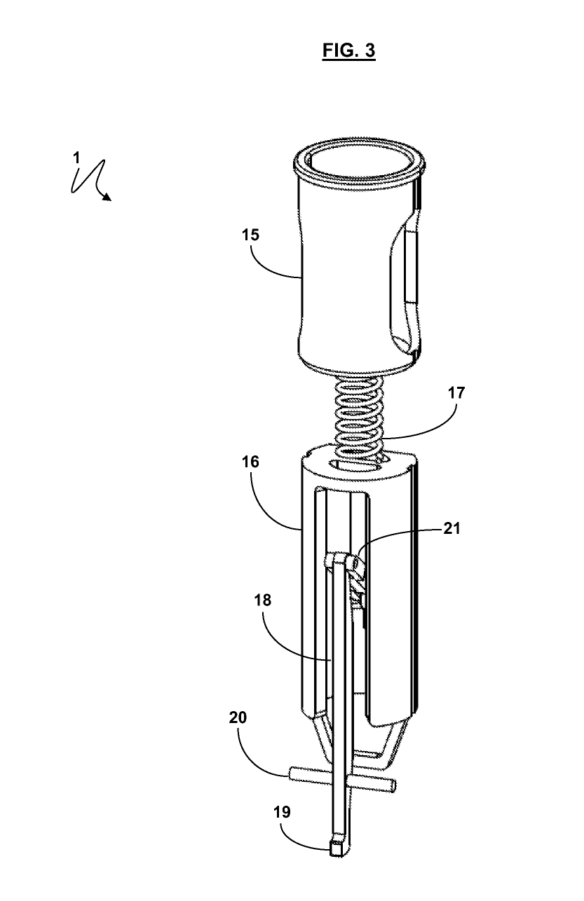

FIG. 3 illustrates the internal components of the trap 1, including support member 15, animal bait reservoir support structure 16, and tension spring 17 disposed therebetween.

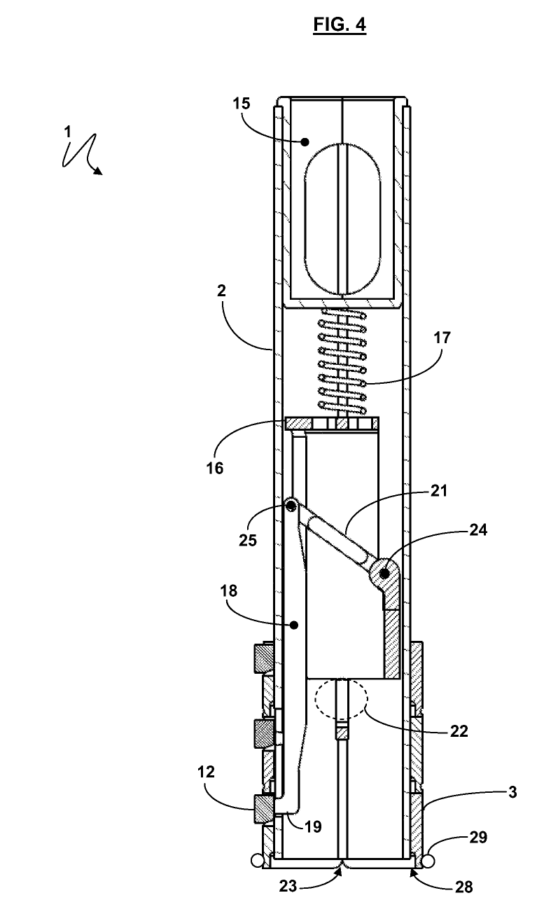

A release mechanism including lever 18, trip hammer 19, pivot support 20, and pivot link 21 is also illustrated. Operation of the release mechanism will be further discussed with reference to FIG. 4.

FIG. 4 provides a cross sectional view of the trap 1.

In operation, an animal is attracted to bait positioned within a bait reservoir located in the area indicated by dashed circle 22. On inserting their head into the housing 2 via opening 23, the animal pulls on the bait. This action draws the animal bait reservoir support structure 16 downwards. In doing so, pivot point 24 is also drawn downwards. Pivot link 21 is in turn drawn downwards and towards the opposite side of the housing to trip hammer 19. Lever 18 is pulled by the movement of the pivot link 21 by their connection at pivot point 25.

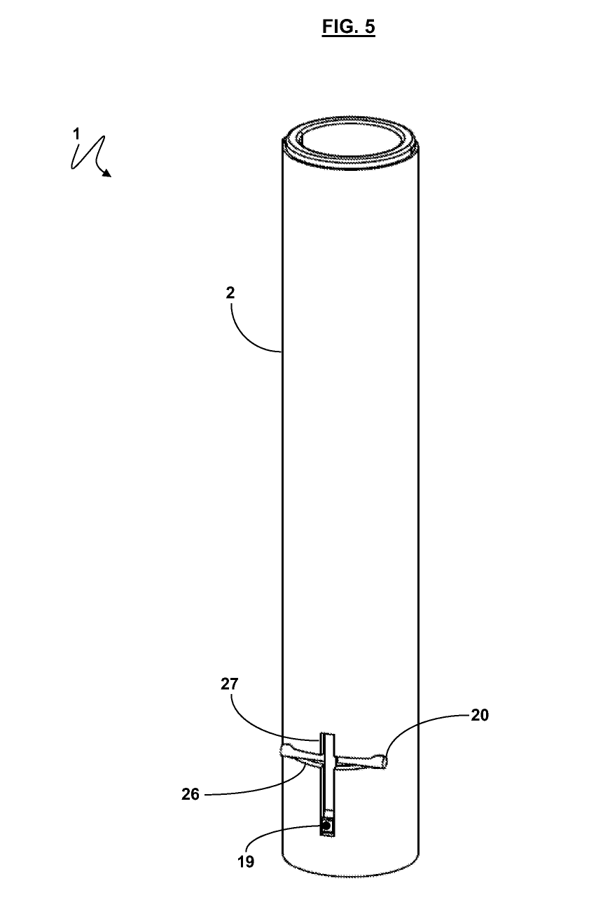

This causes the lever 18 to rotate about pivot support 20. As illustrated by FIG. 5, the pivot support 20 is located in a horizontal slot 26 in the housing 2—bearing against the housing 2 during movement of the release mechanism. A portion of the lever 18, and the trip hammer 19 are permitted to extend through the housing via vertical slot 27.

Returning to FIG. 4, the carrier 3 is seated on lip 28 of the housing 2, with resilient band 29 positioned adjacent to the opening 23.

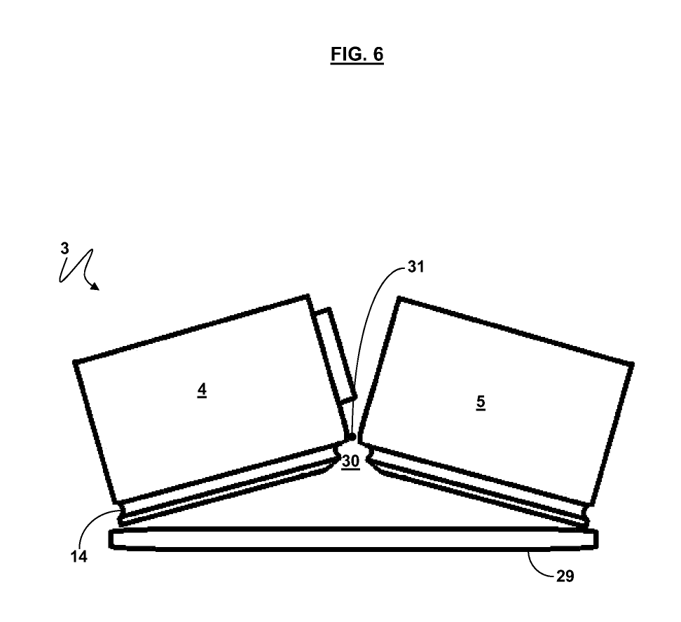

Rotation of the lever 18 about pivot support 20 causes the trip hammer 19 to contact the end 12 of the latch 10, forcing it from aperture 13. Referring to FIG. 6, the carrier 3 includes a gap 30 between the sections 4 and 5 proximal to the downwards edge at which the resilient loop is carried. This gap 30 may be formed by a curved or linear line between the bottom edge and the edge between which the sections are joined.

The gap 30 creates a pivot point 31 above the groove 14 positioning the resilient band 29. Tension in the resilient band 29 causes the sections 4 and 5 to pivot about pivot point 31, until the point where the band 29 is released from the groove 14 onto the neck of the animal, the sections 4 and 5 fall away from the housing 2, and the next carrier 3 settles into place against lip 28.

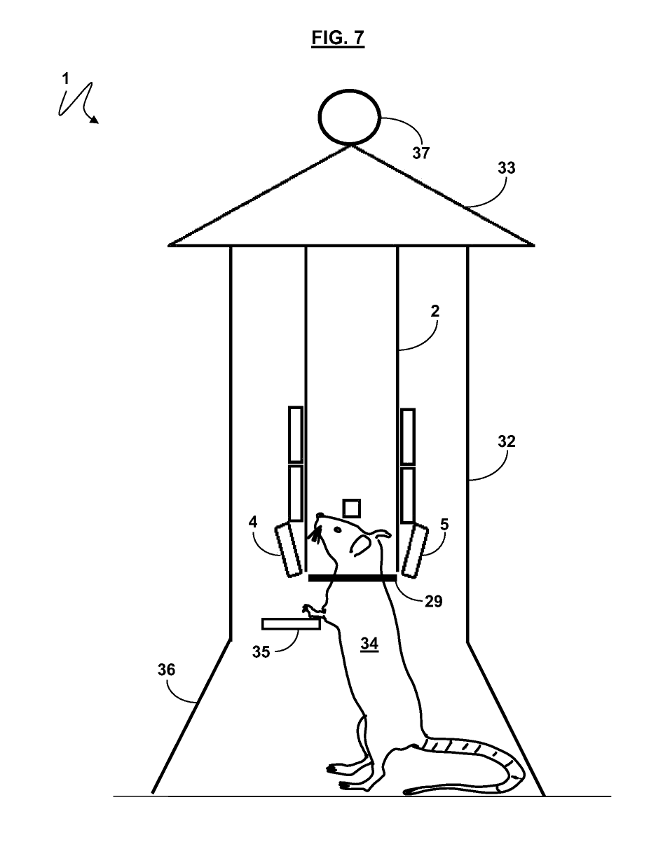

FIG. 7 illustrates the trap 1 including cover 32 within which the housing 2 is positioned, covered by a roof 33.

The target position of rat 34 is illustrated, where its upper limbs are rested on a protrusion 35 from the cover 32. In doing so, the way is cleared for the resilient band 29 to contract directly onto the neck of the rat 34.

In order to assist in achieving this position, the cover 32 may include adjustable legs 36 to allow for the height of the cover 32 and thus housing 2 to be adjusted relative to ground. Alternatively, the cover 32 may be hung from ring 37 in order to achieve the desired height.

Aspects of the present invention have been described by way of example only and it should be appreciated that modifications and additions may be made thereto without departing from the scope thereof as defined in the appended claims.

1. An apparatus for trapping animals, comprising:
a reservoir for animal bait; and
a tubular housing for the reservoir, the housing having a lower end having an opening, wherein the lower end is configured with a stop located on its outer circumference proximate to the opening of the housing;
a plurality of resilient loops; and
a release mechanism for the loops; and
a carrier is provided for each loop, the carrier configured to be slidably moveable about the outer circumference of the housing when the housing is in a substantially vertical orientation, and wherein the release mechanism is configured to be activated to move the loop from its carrier onto the body of an animal activating the release mechanism.

2. The apparatus as claimed in claim 1, wherein the carrier is configured to carry the resilient loop proximate to a downwards facing edge of the carrier.

3. The apparatus as claimed in claim 1, wherein the carrier includes at least two sections which abut each other at a minimum of one point around the circumference of the carrier.

4. The apparatus as claimed in claim 3, wherein the carrier includes a gap between a portion of the sections.

5. The apparatus as claimed in claim 4, wherein the gap is located proximal to a downwards edge at which the resilient loop is carried.

6. The apparatus as claimed in claim 3, wherein the carrier includes a holding means configured to hold the at least two sections together until released.

7. The apparatus as claimed in claim 6, wherein the holding means is a latch.

8. The apparatus as claimed in claim 7, wherein the latch includes a first end and a second end, wherein the latch includes a hinged connection to a section of the carrier at the first end, with the second end configured to engage with a receptacle on another section.

9. The apparatus as claimed in claim 1, wherein the release mechanism is directly or indirectly linked to the bait reservoir.

10. The apparatus as claimed in claim 1, wherein the release mechanism includes a biasing means configured to return the release mechanism to an original position following actuation of the release mechanism.

11. The apparatus as claimed in claim 1, wherein the release mechanism includes a trip member.

12. The apparatus as claimed in claim 11, wherein the release mechanism includes a lever configured to rotate about at least one pivot point and the trip member is a hammer on an end of the lever.

13. The apparatus as claimed in claim 1, wherein the housing is orientated substantially vertically.

14. The apparatus as claimed in claim 1, including a protrusion located below the reservoir at a distance such that an animal attempting access to the reservoir is likely to rest its limbs on the protrusion.

15. A carrier for carrying a resilient loop, comprising: the carrier being configured to slideably move along a housing for an apparatus for trapping animal; wherein the housing is configured with a lower end having an opening; wherein the lower end is configured with a stop located on its outer circumference proximate to the opening of the housing; and
said carrier being dimensioned such that when carrying a resilient loop, an internal circumference of the carrier is such that the carrier is unable to pass the stop of the housing.

16. The carrier as claimed in claim 15, wherein the carrier is configured to carry the resilient loop proximate to a downwards facing edge of the carrier.

17. The carrier as claimed in claim 15, wherein the carrier includes at least two sections which abut each other at a minimum of one point around the circumference of the carrier.

18. The carrier as claimed in claim 17, wherein the carrier includes a gap between a portion of the sections.

19. The carrier as claimed in claim 18, wherein the gap is located proximal to a downwards edge at which the resilient loop is carried.

20. The carrier as claimed in claim 17, wherein the carrier includes a holding means configured to hold the at least two sections together until released.

21. The carrier as claimed in claim 20, wherein the holding means is a latch.

22. The carrier as claimed in claim 21, wherein the latch includes a first end and a second end, wherein the latch includes a hinged connection to a section of the carrier at the first end, with the second end configured to engage with a receptacle on another section.

23. A method of trapping animals using an apparatus, wherein the apparatus includes a reservoir for animal bait, and a tubular housing for the reservoir, the housing having a lower end having an opening, wherein the lower end is configured with a flange about its outer circumference proximate to the opening of the housing, a plurality of resilient loops, and a release mechanism for the loops, wherein the apparatus includes a carrier for each loop, the carrier configured to be slideably moveable about the outer circumference of the housing when the housing is in a substantially vertical orientation, and wherein the release mechanism is configured to be activated to move the loop from its carrier onto the body of an animal activating the release mechanism, wherein the method comprises:
a) placing the apparatus in a substantially vertical orientation;
b) placing bait for the animal into the reservoir; and
c) positioning the carrier relative to the release mechanism such that when activated by an animal, the release mechanism moves the loop from its carrier onto the body of the animal.

24. (canceled)

25. (canceled)

26. (canceled)
